(19) United States
(12) Patent Application Publication
(10) Pub. No.: US 2004/0119217 A1
(43) Pub. Date: Jun. 24, 2004

(54) Mono-tube type hydraulic shock absorber

(76) Inventor: Kenkichi Kon, Tokyo (JP)

Correspondence Address: RABIN & Berdo, PC, 1101 14TH STREET, NW, SUITE 500, WASHINGTON, DC, 20005, US

(21) Appl. No.: 10/721,236

(22) Filed: Nov. 26, 2003

(30) Foreign Application Priority Data
Dec. 18, 2002 (JP) 2002-367003

(51) Int. Cl. B60G 15/00; F16F 11/00

(52) U.S. Cl. 267/221; 188/322.19

(57) ABSTRACT

This invention provides a mono-tube type shock absorber comprising: a spring receiver that holds a lower end of a suspension spring, the suspension spring urging the mono-tube type shock absorber in a direction of extending the mono-tube type shock absorber; a cylinder constituting the mono-tube type shock absorber; and a guide member to which the spring receiver is fixed, the guide member being fixed to an outer circumferential surface of the cylinder, wherein: the guide member is disposed with a predetermined gap being provided between the guide member and the cylinder; an upper end portion of the guide member is fixed to an upper end portion of the cylinder; a lower end portion of the guide member is open with respect to the cylinder; and the spring receiver is fixed to the lower end portion of the guide member.

### FIELD OF THE INVENTION

This invention relates to a mono-tube type hydraulic shock absorber of a vehicle.

### BACKGROUND OF THE INVENTION

FIG. 3 shows one example of a conventional mono-tube type hydraulic shock absorber.

With this shock absorber, a spring receiver 3 for fixing a suspension spring 2 is welded to a guide member 4. Welding deformation thus does not develop in a cylinder 11 due to welding of the spring receiver 3 to the guide member 4. Welding deformation therefore exerts no influence on piston sliding within the cylinder 11.

When the guide member 4 is to be welded to the cylinder 11, a lower end portion 4a of the guide member 4 is welded to a bottom end portion 11a of the cylinder 11. Even if welding deformation develops in the cylinder 11 during welding at this time, any influence caused by the welding deformation can thus be suppressed. That is, the welding deformation does not exert influence on the sliding of the piston within the cylinder 11.

Further, an upper end portion 4b is fixed to the cylinder 11 by calking, and thermal deformation such as welding deformation does not develop in the cylinder.

However, there is a problem with this type of conventional shock absorber in that heat generated by sliding of a rod 12 cannot be sufficiently dissipated. As a result, dispersion develops in the characteristics of the damping force that is generated.

That is, in the conventional shock absorber, the guide member 4 is disposed in an outside of the cylinder 11 that constitutes a main body 1, and upper and lower ends of the guide member 4 are fixed to the cylinder 11. A closed space defined by a gap S between the cylinder 11 and the guide member 4 is therefore formed. That is, an air layer closed into a cylindrical shape is formed between the guide member 4 and the cylinder 11.

In particular, the cylindrical air layer is formed along an outer circumferential surface of the cylinder 11, over nearly the entire length of the cylinder 11, when the guide member 4 covers the cylinder 11 from the bottom end portion 11a of the cylinder 11 to the vicinity of a head end portion 11b in the cylinder 11.

The air layer therefore becomes a heat insulating layer, and the heat insulating layer impedes heat dissipation from the cylinder 11. As a result, the amount of heat that is dissipated from the cylinder 11 to the ambient atmosphere decreases considerably, and the temperature of a working fluid within the cylinder 11 increases. The damping force characteristics thus cannot maintain a fixed value.

It is therefore an object of this invention to provide a shock absorber which is capable of ensuring cylinder heat dissipation to provide a predetermined damping action in a stable manner.

### SUMMARY OF THE INVENTION

In order to achieve above object, this invention provides a mono-tube type shock absorber comprising: a spring receiver that holds a lower end of a suspension spring, the suspension spring urging the mono-tube type shock absorber in a direction of extending the mono-tube type shock absorber; a cylinder constituting the mono-tube type shock absorber; and a guide member to which the spring receiver is fixed, the guide member being fixed to an outer circumferential surface of the cylinder, wherein: the guide member is disposed with a predetermined gap being provided between the guide member and the cylinder; an upper end portion of the guide member is fixed to an upper end portion of the cylinder; a lower end portion of the guide member is open with respect to the cylinder; and the spring receiver is fixed to the lower end portion of the guide member.

### BRIEF DESCRIPTION OF THE DRAWINGS

FIG. 1 is a front view that shows a mono-tube type shock absorber of this invention.

FIG. 2 is a partial front view that shows main portions of the mono-tube type shock absorber of FIG. 1.

FIG. 3 is a view that shows a mono-tube type shock absorber according to a conventional example.

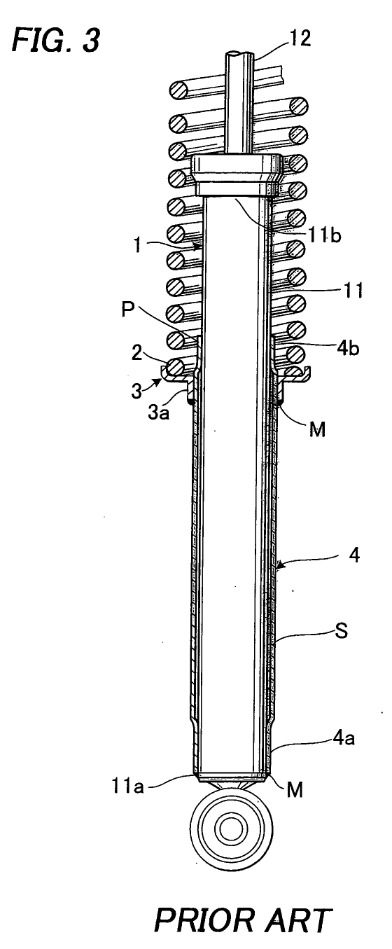

### DETAILED DESCRIPTION OF THE PREFERRED EMBODIMENTS

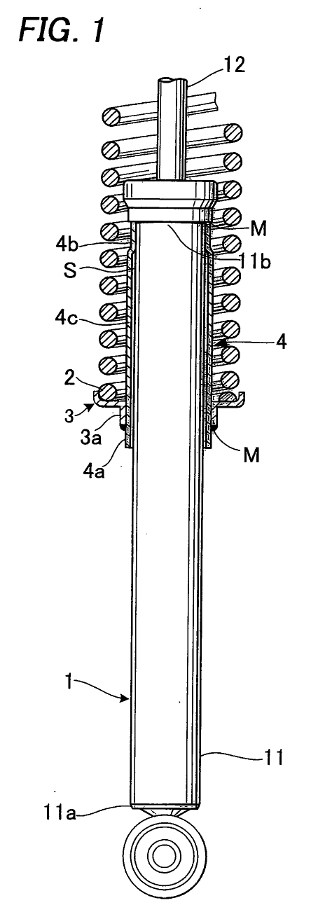

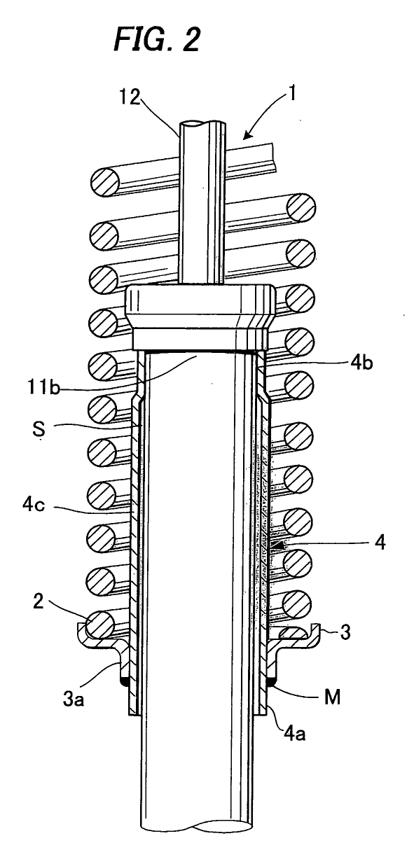

Based on FIG. 1 and FIG. 2, an embodiment of this invention is explained.

A mono-tube type shock absorber of this invention is constructed from a main body 1, a spring receiver 3 that supports a lower end of a suspension spring 2 that urges the main body 1 in a direction of extending the main body 1, and a guide member 4 that is fixed to an outer circumferential surface of the main body 1.

The guide member 4 is formed in a cylindrical shape, and is disposed coaxially with the cylinder 11, maintaining a predetermined gap S therebetween. While maintaining the gap S, an upper end portion 4b of the guide member 4 is welded to a head end portion (upper end portion) 11b of the cylinder 11, and is thus fixed to the cylinder 11 (shown by reference symbol M in FIG. 1).

The guide member 4 is disposed having the gap S provided between the guide member 4 and the cylinder 11, and consequently does not contact with the cylinder 11 at a main body portion 4c and at a lower end portion 4a, which are below the upper end upper end portion 4b. The lower end portion 4a of the guide member 4 is thus is open to an outside portion, with the gap S being provided between the lower end portion 4a and the cylinder 11. Air within the gap S therefore takes heat away from the cylinder 11 and dissipates the heat to the ambient atmosphere, thereby suppressing temperature increases in the cylinder 11.

It should be noted that welding deformation also develops when the upper end portion 4b of the guide member 4 is welded to the head end portion 11b of the cylinder 11. However, the welding deformation develops in the head end portion 11b in the cylinder 11 and thus does not affect sliding of a piston (not shown) within the cylinder 11.

That is, as is well known, the piston slides in the shock absorber in a state where an outer circumference of the piston contacts an inner circumference of the cylinder 11. The piston normally slides within such a range that it does not reach the bottom end portion (lower end portion) 11a and the head end portion 11b of the cylinder 11. Therefore, there is no influence on piston sliding, even if welding deformation appears in the bottom end portion 11a and the head end portion 11b.

Furthermore, even when the upper end portion 4b of the guide member 4 is fixed to the head end portion 11b of the cylinder 11 by press fitting instead of welding, deformation that develops due to press fitting, for reasons similar to those in the case of welding, does not affect sliding of the cylinder 11.

Referring to FIG. 2, the spring receiver 3 is fixed to the lower end portion 4a of the guide member 4 by welding. The guide member 4 is welded to the cylinder 11 after the spring receiver 3 is welded to the guide member 4. Welding deformation that develops when the spring receiver 3 is welded to the guide member 4 thus does not affect sliding of the cylinder 11.

As shown in the figures, in this embodiment, the lower end position of the suspension spring 2, which is determined according to design requirements and the like, is a position closer to the head portion 11b than to the bottom portion 11a of the cylinder 11. The upper end portion 4b of the guide member 4 is accordingly fixed to the head end portion 11b of the cylinder 11 by welding, and the spring receiver 3 is fixed to the lower end portion 4a. The length of the guide member 4 in a longitudinal direction of the cylinder can thus be set shorter, and an air layer that is formed by the gap S between the guide member 4 and the cylinder 11 can be made shorter.

The cylindrical air layer formed by the gap S along the outer circumferential surface of the cylinder 11 can therefore be made smaller. Thus, heat from the cylinder 11 can be effectively dissipated to the ambient atmosphere, suppressing temperature increases of the working fluid within the cylinder 11 to attain stable damping force characteristics.

Further, one end of the guide member 4 is open to the ambient atmosphere with this invention, and thus air in the gap S can take heat away from the cylinder S and dissipate the heat to the ambient atmosphere. Heat dissipation is thus also performed effectively from the outer surface of the cylinder 11, which is covered by the guide member 4.

It should be noted that a plurality of holes may also be formed in the guide member 4 in order to promote the heat dissipation effect. Furthermore, generation of sounds due to the contact between the lower end portion 4a of the guide member 4 and the cylinder 11 can be prevented by disposing a sealing material between the lower end portion 4a of the guide member 4 and the cylinder 11.

The mono-tube type shock absorber is explained in this embodiment by using a so-called conventional type shock absorber, but the mono-tube type shock absorber can also be applied to an upside down type shock absorber.

Further, while in this embodiment the spring receiver 3 and the guide member 4 are provided separately and the spring receiver 3 is fixed to the guide member 4 by welding, the spring receiver 3 and the guide member 4 may also be formed integrally in advance.

As described above, the mono-tube type shock absorber of this invention has the spring receiver that supports the lower end of the suspension spring that urges the shock absorber in a direction of extending the shock absorber, and the guide member to which the spring receiver is fixed and which is fixed to outer circumferential surface of the cylinder that constitutes the shock absorber. The guide member is disposed having the predetermined gap provided between the guide member and the cylinder. The upper end portion of the guide member is fixed to the upper end portion of the cylinder, and the lower end portion of the guide member is open with respect to the cylinder. The spring receiver is fixed to the lower end portion of the guide member. The predetermined gap that is formed between the guide member and the cylinder is therefore in an open state at the lower end portion of the guide member. Air within the gap is released to the ambient atmosphere from the open lower end portion. The air absorbs heat from the cylinder, and the heat from the cylinder can thus be effectively dissipated via the air. As a result, the damping characteristics of the shock absorber can be always maintained constant.

Furthermore, the upper end portion of the guide member is fixed to the upper end portion of the cylinder. Except at the upper end portion of the guide member, the guide member is disposed with the predetermined gap being provided between the guide member and the outer circumferential surface of the cylinder, and the spring receiver is fixed to the lower end portion of the guide member. The guide member is thus fixed to the upper end portion of the cylinder near the lower end of the suspension spring, and consequently the guide member can be made shorter. The air layer that interferes with heat dissipation from the cylinder can consequently be made shorter, and the cylinder heat dissipation can be improved.

Still further, the guide member 4 is constructed in a cylindrical shape, and therefore the spring receiver 3 can be fixed with reliability while the predetermined gap S is maintained between the guide member 4 and the cylinder 11.

For cases where the spring receiver 3 is welded to the guide member 4, it becomes possible to ensure that heat does not reach the cylinder 11 during welding. Welding deformation of the cylinder, which interferes with sliding of the piston within the cylinder, can therefore be prevented.

As a result, according to this invention, a shock absorber can be provided in which dissipation of heat from the cylinder can be performed with good efficiency to obtain a necessary cooling effect and stably maintain predetermined damping characteristics.

What is claimed is:

1. A mono-tube type shock absorber comprising:
a spring receiver that holds a lower end of a suspension spring, the suspension spring urging the mono-tube type shock absorber in a direction of extending the mono-tube type shock absorber;
a cylinder constituting the mono-tube type shock absorber; and
a guide member to which the spring receiver is fixed, the guide member being fixed to an outer circumferential surface of the cylinder,
wherein:
the guide member is disposed with a predetermined gap being provided between the guide member and the cylinder;
an upper end portion of the guide member is fixed to an upper end portion of the cylinder;
a lower end portion of the guide member is open with respect to the cylinder; and
the spring receiver is fixed to the lower end portion of the guide member.

2. The mono-tube type shock absorber according to claim 1, wherein the guide member is constructed in a cylindrical shape.

3. The mono-tube type shock absorber according to claim 1, wherein the spring receiver is welded to the guide member.
